(19) United States
(12) Patent Application Publication
(10) Pub. No.: US 2025/0103112 A1
(43) Pub. Date: Mar. 27, 2025

(54) PORTABLE BLOCKCHAIN MINING SYSTEMS AND METHODS OF USE

(71) Applicant: UPSTREAM DATA INC., Lloydminster (CA)

(72) Inventors: Stephen Barbour, Calgary (CA); Brett Rowan, Lloydminster (CA)

(21) Appl. No.: 18/727,109

(22) PCT Filed: Jan. 6, 2022
(86) PCT No.: PCT/CA2022/050011

§ 371 Date: Jul. 8, 2024

(51) Int. Cl. G06F 1/20; G06F 1/18

(52) U.S. Cl. CPC G06F 1/20; G06F 1/183

(57) ABSTRACT

Portable blockchain mining systems and methods of use are discussed here. A blockchain mining system is has a portable housing, formed of panels that cooperate to form an enclosure; an air inlet defined in an inlet panel of the panels; an air outlet defined in an outlet panel of the panels; an internal frame within the portable housing, the internal frame defining a cooling air passageway that includes: a labyrinthine inlet conduit to the air inlet; a blockchain mining processor mounting zone that is connected to the labyrinthine inlet conduit; and a labyrinthine outlet conduit to the blockchain mining processor mounting zone and the air outlet. Methods include operating a blockchain mining processor in a portable housing of a blockchain mining system to process blockchain transactions, while a cooling fan moves cooling air in series: through a labyrinthine inlet conduit defined within the portable housing; across the blockchain mining processor; and through a labyrinthine outlet conduit defined within the portable housing; to maintain the plurality of blockchain mining processors within a respective operating range of temperature.

### TECHNICAL FIELD

This document relates to portable blockchain mining systems and methods of use.

### BACKGROUND

Portable enclosures, such as modified intermodal transport container units are known to be used to house plural cryptocurrency mining processors connected through the internet to verify cryptocurrency transactions. There is a need to allow blockchain mining processors to operate outdoors with limited sound, noise and also have fire suppression.

### SUMMARY

A system is disclosed comprising a portable blockchain mining system and a power source connected to supply power to the portable blockchain mining system.

A blockchain mining system is disclosed comprising: a portable housing, formed of panels that cooperate to form an enclosure; an air inlet defined in an inlet panel of the panels; an air outlet defined in an outlet panel of the panels; an internal frame within the portable housing, the internal frame defining a cooling air passageway that includes: a labyrinthine inlet conduit to the air inlet; a blockchain mining processor mounting zone that is connected to the labyrinthine inlet conduit; and a labyrinthine outlet conduit to the blockchain mining processor mounting zone and the air outlet.

A method is disclosed comprising operating a blockchain mining processor in a portable housing of a blockchain mining system to process blockchain transactions, while a cooling fan moves cooling air in series: through a labyrinthine inlet conduit defined within the portable housing; across the blockchain mining processor; and through a labyrinthine outlet conduit defined within the portable housing; to maintain the plurality of blockchain mining processors within a respective operating range of temperature.

In various embodiments, there may be included any one or more of the following features: An air mover connected to direct air through the cooling air passageway from the air inlet to the air outlet. The blockchain mining processor mounting zone is elevated above the base to a position adjacent a roof of the panels. The panels define or form a processor access door that is structured to open to the blockchain mining processor mounting zone. A roof of the panels forms the processor access door and is pivotally connected to a side wall of the panels. A side wall of the panels forms the processor access door. The processor access door comprises peripheral weatherstripping. The air inlet is defined in an inlet side wall of the panels. The air outlet is defined in an outlet side wall of the panels. The air inlet and air outlet are located adjacent base ends of the inlet side wall and outlet side wall, respectively. The inlet side wall and the outlet side wall are opposite one another. The internal frame comprises a divider wall separating the labyrinthine inlet conduit and labyrinthine outlet conduit. The divider wall at least partially bisects the enclosure. The blockchain mining processor mounting zone comprises a shelf supported by the divider wall above the divider wall. An adjustable air recirculation valve connected to permit a controlled range of bypass of air from the labyrinthine outlet conduit back to the labyrinthine inlet conduit. The adjustable air recirculation valve comprises a slider door mounted to a recirculation port. The labyrinthine inlet conduit comprises one or more inlet conduit portions connected in series between the air inlet and the blockchain mining processor mounting zone, with each downstream inlet conduit portion of the one or more inlet conduit portions oriented to define a downstream inlet conduit portion axis angled at ninety degrees or more from an upstream inlet conduit portion axis of an adjacent upstream inlet conduit portion of the one or more inlet conduit portions. The one or more inlet conduit portions comprise: a first inlet conduit portion connected to the air inlet; a second inlet conduit portion connected to the first inlet conduit portion and defining a second inlet conduit portion axis angled at ninety degrees or more from a first inlet conduit portion axis of the first inlet conduit portion; a third inlet conduit portion connected to the second inlet conduit portion and defining a third inlet conduit portion axis angled at ninety degrees or more from the second inlet conduit portion axis; and a fourth inlet conduit portion connected to the third inlet conduit portion and the blockchain mining processor mounting zone and defining a fourth inlet conduit portion axis angled at 90 degrees or more from the third inlet conduit portion axis. The downstream and upstream inlet conduit portion axes are defined in a common plane. Each downstream inlet conduit portion has a respective diverter wall structured to change air flow direction by at least ninety degrees from the adjacent upstream inlet conduit portion and to block all lines of sight from the adjacent upstream inlet conduit portion into the downstream inlet conduit portion. The labyrinthine outlet conduit comprises one or more outlet conduit portions connected in series between the blockchain mining processor mounting zone and the air outlet, with each downstream outlet conduit portion of the one or more outlet conduit portions oriented to define a downstream outlet conduit portion axis angled at ninety degrees or more from an upstream outlet conduit portion axis of an adjacent upstream outlet conduit portion of the one or more outlet conduit portions. The one or more outlet conduit portions comprise: a first outlet conduit portion connected to the blockchain mining processor mounting zone; a second outlet conduit portion connected to the first outlet conduit portion and defining a second outlet conduit portion axis angled at ninety degrees or more from a first outlet conduit portion axis of the first outlet conduit portion; a third outlet conduit portion connected to the second outlet conduit portion and defining a third outlet conduit portion axis angled at ninety degrees or more from the second outlet conduit portion axis; and a fourth outlet conduit portion connected to the third outlet conduit portion and the air outlet and defining a fourth outlet conduit portion axis angled at 90 degrees or more from the third outlet conduit portion axis. The downstream and upstream outlet conduit portion axes are defined in a common plane. Each downstream outlet conduit portion has a respective diverter wall structured to change air flow direction by at least ninety degrees from the adjacent upstream outlet conduit portion and to block all lines of sight from the adjacent upstream outlet conduit portion into the downstream outlet conduit portion. A pressure barrier oriented across the cooling air passageway within the blockchain mining processor mounting zone, the pressure barrier defining a discharge port structured to mount to a discharge end of a body of a blockchain mining processor. The internal frame defines a central plane of symmetry between the air inlet and the air outlet. One or more of the panels comprise acoustic insulation. An inlet filter over the air inlet; and an outlet filter over the air outlet. A width of the portable housing is ninety-six inches or greater. In some cases, the width of the portable housing is less than ninety-six inches, for example sixteen inches or larger, although other sizes larger or smaller than ninety-six inches may be used. The enclosure is a weatherproof enclosure. A blockchain mining processor mounted within the blockchain mining processor mounting zone. A plurality of blockchain mining processors mounted within the blockchain mining processor mounting zone. The plurality of blockchain mining processors are mounted in parallel along a lateral mounting axis transverse to an air flow axis defined across the blockchain mining processors within the blockchain mining processor zone. Each blockchain mining processor comprises one or more of: a body; a processor board mounted on the body and containing one or more application-specific integrated circuit chips; a controller; a power connector; a network connector; and one or more fans connected to direct air through the cooling air passageway across the blockchain mining processor to maintain the blockchain mining processor within a respective operating range of temperature. The one or more fans comprise one or more of: an intake fan at an intake end of the body; and a discharge fan at a discharge end of the body. Operating the blockchain mining processor of the blockchain mining system to process blockchain transactions. The cooling fan moves cooling air through an air inlet defined in an inlet in the portable housing into the labyrinthine inlet conduit. Cooling air recirculates through an adjustable air recirculation valve from the labyrinthine outlet conduit back to the labyrinthine inlet conduit. The cooling fan moves cooling air through the labyrinthine outlet conduit and to an air outlet defined in an outlet in the portable housing. The blockchain mining processor has a network interface; the network interface is connected to receive and transmit data through the internet to a network that stores or has access to a blockchain database; and the mining processor is connected to the network interface and adapted to mine transactions into blocks associated with the blockchain database and to communicate with the blockchain database. The network is a peer-to-peer network; the blockchain database is a distributed database stored on plural nodes in the peer-to-peer network; and the blockchain database stores transactional information for a digital currency. Operating the blockchain mining system to: mine transactions with the blockchain mining system, for example by mining the most recent block on the blockchain with the blockchain mining system; and communicate wirelessly through the internet to communicate with a blockchain database. The network interfaces comprise one or more of a satellite, cellular, or radio antenna, connected to a modem. Successfully mining a block by a mining processor provides a reward of the digital currency, and the reward is assigned to a digital wallet or address stored on a computer readable medium. The system runs on polyphase (three phase) power or single-phase power. The portable housing has height dimensions of less than four feet. The portable housing forms a ground engaging skid. Two or more portable blockchain mining modules are secured together to form a wall of portable blockchain mining modules. The modules may be located anywhere, for example inside or outside a building. Two or more of the portable blockchain mining modules are stacked in a vertical stack one on top of the other, resting on each other by gravity and/or secured together using respective module mounting mechanisms. Two or more of the portable blockchain mining modules are arranged in a horizontal row, and unsecured or secured together using respective module mounting mechanisms. The portable blockchain mining modules are aligned such that the air inlets are located on a first side of the wall, and the air outlets are located on a second side of the wall. The portable blockchain mining modules are connected to receive power from a central power source. Before operating, stacking the plurality of portable blockchain mining modules in the vertical stack by securing the base of the first portable blockchain mining module to the roof of the second portable blockchain mining module. The wall has a horizontal row of two or more portable blockchain mining modules, with a side wall of one portable blockchain mining module secured to a side wall of another portable blockchain mining module.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of a portable blockchain mining system, with a top lid open.

FIG. 1A is a cutaway side elevation view of the portable blockchain mining system of FIG. 1 with acoustic insulation panels disposed about interior surfaces of the internal framework.

FIG. 2 is a perspective view of an ASIC processor unit from the system of FIG. 1, configured for blockchain mining and connected to a pressure barrier.

FIG. 3 is a perspective cutaway view of the portable blockchain mining system of FIG. 1, with a side wall removed, the lid open, and one of two ASIC units removed.

FIG. 4 is a perspective cutaway view of the portable blockchain mining system of FIG. 1, with a side wall removed to view the internal diverter (baffle) walls and air circulation paths.

FIG. 5 is a perspective view of a series of portable blockchain mining systems, including the portable blockchain mining system of FIG. 1 on the right, differing from one another in width and number of ASIC processor units contained therein, to indicate how the system of FIG. 1 may be scaled up or down in terms of processing capacity.

FIG. 6 is a cutaway side elevation view of the portable blockchain mining system of FIG. 4.

FIG. 7 is a cutaway side elevation view of a portable blockchain mining system, with a side wall removed and an air recirculation valve fully closed.

FIG. 8 is a cutaway side elevation view of the portable blockchain mining system of FIG. 7, with the air recirculation valve fully open, and showing a partially open position in dashed lines.

FIG. 9 is a perspective view of the portable blockchain mining system of FIG. 7 (air recirculation valve fully closed).

FIG. 10 is a perspective view of the portable blockchain mining system of FIG. 8 (air recirculation valve fully open).

FIG. 11 is a perspective view of a plurality of the portable blockchain mining systems of FIG. 1 arranged in a horizontal row.

FIG. 12 is a perspective view of a plurality of the portable blockchain mining systems of FIG. 1 arranged and stacked in a vertical row.

FIG. 13 is a perspective view of a plurality of the portable blockchain mining systems of FIG. 1 arranged in a horizontal row of two vertical stacked rows.

### DETAILED DESCRIPTION

Immaterial modifications may be made to the embodiments described here without departing from what is covered by the claims.

A cryptocurrency (or crypto currency) is a digital asset designed to work as a medium of exchange that uses strong cryptography to secure financial transactions, control the creation of additional units, and verify the transfer of assets. Cryptocurrencies use decentralized control as opposed to centralized digital currency and central banking systems. The decentralized control of each cryptocurrency works through distributed ledger technology, typically a blockchain that serves as a public financial transaction database.

A blockchain is a form of database, which may be saved as a distributed ledger in a network of nodes that maintains a continuously growing list of records called blocks. Each block contains a timestamp and a link to a previous block. The data in a block cannot be altered retrospectively without significant computational effort and majority consensus of the network. The first blockchain was allegedly conceptualized by Satoshi Nakamoto in 2008 and implemented the following year as a core component of the digital currency Bitcoin, where it serves as the public ledger for all transactions. Through the use of a peer-to-peer network and a distributed timestamping server, a blockchain database is managed autonomously. The administration of Bitcoin currency is currently the primary use for blockchain technology, but there are other use cases for blockchain technology to maintain accurate, tamper-proof databases. Examples include maintaining records of land titles and historical events. While the potential in blockchain technology is vast, Bitcoin remains the most widely used today.

By design blockchains are inherently resistant (and assumed to be effectively impervious) to modification of the data—once recorded, the data in a block cannot be altered retroactively without network consensus. Blockchains are an open, distributed ledger that can record transactions between two parties efficiently and in a verifiable and permanent way. The ledger itself can also be programmed to trigger transactions automatically. Blockchains are secure by design and an example of a distributed computing system with high byzantine fault tolerance. Decentralized consensus can therefore be achieved with a blockchain. This makes the blockchain model suitable for the recording of events, medical records, and other records management activities, identity management, transaction processing and proving provenance. This offers the potential of mass disintermediation and vast repercussions for how global trade is conducted.

A blockchain facilitates secure online transactions. A blockchain is a decentralized digital ledger that records transactions on thousands of computers globally in such a way that the registered transactions cannot be altered retrospectively. This allows the participants to verify and audit transactions in an inexpensive manner. Transactions are authenticated by mass collaboration powered by collective self-interests. The result is a robust workflow where participants' uncertainty regarding data security is marginal. The use of a blockchain removes the characteristic of infinite reproducibility from a digital asset. It confirms that each unit of digital cash was spent only once, solving the long-standing problem of double spending. Blockchains have been described as a value-exchange protocol. This exchange of value can be completed more quickly, more safely and more cheaply with a blockchain. A blockchain can assign title rights because it provides a record that compels offer and acceptance. From the technical point of view a blockchain is a hash chain inside another hash chain.

A blockchain database may comprise two kinds of records: transactions and blocks. Blocks may hold batches of valid transactions that are hashed and encoded into a Merkle tree. Each block may include the hash of the prior block in the blockchain, linking the two. Variants of this format were used previously, for example in Git, and may not by itself be sufficient to qualify as a blockchain. The linked blocks form a chain. This iterative process confirms the integrity of the previous block, all the way back to the original genesis block. Some blockchains create a new block as frequently as every five or fewer seconds. As blockchains age they are said to grow in height. Blocks are structured by division into layers.

Sometimes separate blocks may be validated concurrently, creating a temporary fork. In addition to a secure hash-based history, each blockchain has a specified algorithm for scoring different versions of the history so that one with a higher value can be selected over others. Blocks that are not selected for inclusion in the chain are called orphan blocks. Peers supporting the database don't have exactly the same version of the history at all times, rather they keep the highest scoring version of the database that they currently know of. Whenever a peer receives a higher scoring version (usually the old version with a single new block added) they extend or overwrite their own database and retransmit the improvement to their peers. There is never an absolute guarantee that any particular entry will remain in the best version of the history forever, but because blockchains are typically built to add the score of new blocks onto old blocks and there are incentives to only work on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. In practice there are a number of methods that can demonstrate a sufficient level of computation. Within a blockchain the computation is carried out redundantly rather than in the traditional segregated and parallel manner.

Maintaining a blockchain database is referred to as mining, which refers to the distributed computational review process performed on each block of data in a block-chain. This allows for achievement of consensus in an environment where neither party knows or trusts each other. Those engaged in Bitcoin mining are rewarded for their effort with newly created Bitcoins and transaction fees, which may be transferred to a digital wallet of a user upon completion of a designated task. Bitcoin miners may be located anywhere globally and may be operated by anyone. The mining hardware is tied to the blockchain network via an internet connection. Thus, little infrastructure is needed to operate and contribute to the system. All that is required to become a Bitcoin miner is the appropriate computer hardware, an internet connection and low-cost electricity. The cheaper the electricity the more reward the miner will receive relative to competition, other miners.

Mining also includes the process of adding transaction records to Bitcoin's public ledger of past transactions. This ledger of past transactions is referred to as the blockchain as it is essentially a chain of blocks. The blockchain serves to confirm transactions to the rest of the network as having taken place. Bitcoin nodes use the blockchain to distinguish legitimate Bitcoin transactions from attempts to re-spend coins that have already been spent elsewhere. Mining may be intentionally designed to be resource-intensive and difficult so that the number of blocks found each day by miners remains steady. Individual blocks may be required to contain a proof-of-work to be considered valid. This proof-of-work is verified by other Bitcoin nodes each time they receive a block. Bitcoin presently uses the hash cash proof-of-work function.

One purpose of mining is to allow Bitcoin nodes to reach a secure, tamper-resistant consensus. Mining may also be the mechanism used to introduce Bitcoins into the system: Miners are paid any transaction fees as well as a subsidy of newly created coins. This both serves the purpose of disseminating new coins in a decentralized manner as well as motivating people to provide security for the system. Bitcoin mining is so called because it resembles the mining of other commodities: it requires exertion and it slowly makes new currency available at a rate that resembles the rate at which commodities like gold are mined from the ground.

Mining requires computational effort in the form of CPU cycles (CPU=central processing unit or central processor) to run a cryptographic hashing algorithm associated with the particular blockchain protocol. For a given mining processor, one can modify the computational effort through changing the core voltage or the clock rate of the processor. Doing so may result in more or less power consumed by the mining processor, and in some embodiments within this document such changes are described as changing the mining activity, or hash rate.

As the total network computational effort (or hash rate) increases on a blockchain over time, the probability for an individual miner to find a block and receive a reward diminishes. Today the Bitcoin network is so large that most individuals engaged in mining Bitcoin typically mine in pools using protocols such as the Stratum Mining Protocol. Pooling resources allows individual miners to increase their reward frequency as a trade-off for splitting the block reward with the rest of the pool. Miners who are pool mining do not need the associated equipment needed to run a mining node as they only need compute and submit proof-of-work shares issued by the mining pool.

Since the energy cost of running blockchain mining equipment is its primary operating cost, a trend towards mining on low-cost hydroelectric power has become prevalent. This trend has promoted the centralization of blockchain miners in specific countries with abundant hydroelectric power, as miners who do not have access to cheap hydroelectricity cannot mine profitably because they are competing with the miners who do have access. Bitcoin mining centralization has been occurring in places where there is abundant low-cost hydroelectric power. Centralization in blockchain mining is undesirable because the premise behind the blockchain innovation is not to have to trust a third party and to have inherent confidence and security through a decentralized, distributed network. Thus, there exists a need to further decentralize Bitcoin and other blockchain mining through a more decentralized source of low-cost power.

Decentralized cryptocurrency is produced by the entire cryptocurrency system collectively, at a rate which is defined when the system is created and which is publicly known. In centralized banking and economic systems such as the US Federal Reserve System, corporate boards or governments control the supply of currency. In the case of decentralized cryptocurrency, companies or governments cannot produce new units, and have not so far provided backing for other firms, banks or corporate entities which hold asset value measured in it. The underlying technical system upon which decentralized cryptocurrencies are based was created by the group or individual known as Satoshi Nakamoto. As of May 2018, over 1,800 cryptocurrency specifications existed. Within a proof-of-work cryptocurrency system such as Bitcoin, the safety, integrity and balance of ledgers is maintained by a community of mutually distrustful parties referred to as miners: who use their computers to help validate and timestamp transactions, adding them to the ledger in accordance with a particular timestamping scheme. In a proof-of-stake (POS) blockchain, transactions are validated by holders of the associated cryptocurrency, sometimes grouped together in stake pools. Most cryptocurrencies are designed to gradually decrease the production of that currency, placing a cap on the total amount of that currency that will ever be in circulation.[44] Compared with ordinary currencies held by financial institutions or kept as cash on hand, cryptocurrencies can be more difficult for seizure by law enforcement.

A cryptocurrency wallet stores the public and private “keys” (address) or seed which can be used to receive or spend the cryptocurrency. With the private key, it is possible to write in the public ledger, effectively spending the associated cryptocurrency. With the public key, it is possible for others to send currency to the wallet. There exist multiple methods of storing keys or seed in a wallet from using paper wallets which are traditional public, private or seed keys written on paper to using hardware wallets which are dedicated hardware to securely store your wallet information, using a digital wallet which is a computer with a software hosting your wallet information, hosting your wallet using an exchange where cryptocurrency is traded. or by storing your wallet information on a digital medium such as plaintext.

Bitcoin is pseudonymous rather than anonymous in that the cryptocurrency within a wallet is not tied to people, but rather to one or more specific keys (or “addresses”). Thereby, bitcoin owners are not identifiable, but all transactions are publicly available in the blockchain. Still, cryptocurrency exchanges are often required by law to collect the personal information of their users. Additions such as Monero, Zerocoin, Zerocash and CryptoNote have been suggested, which would allow for additional anonymity and fungibility.

Blockchains may be used in association with non-currency applications, such as in the case of a non-fungible token (NFT), which is a unique and non-interchangeable unit of data stored on a digital ledger (blockchain). NFTs may be associated with easily-reproducible items such as photos, videos, audio, and other types of digital files as unique items (analogous to a certificate of authenticity). NFTs use blockchain technology to provide a public proof of ownership. Copies of the original file are not restricted to the owner of the NFT, and can be copied and shared like any file. The lack of interchangeability (fungibility) distinguishes NFTs from traditional blockchain cryptocurrencies, such as Bitcoin. The embodiments of this disclosure cover blockchain engaging systems, including those that relate to cryptocurrencies, NFTs, and others.

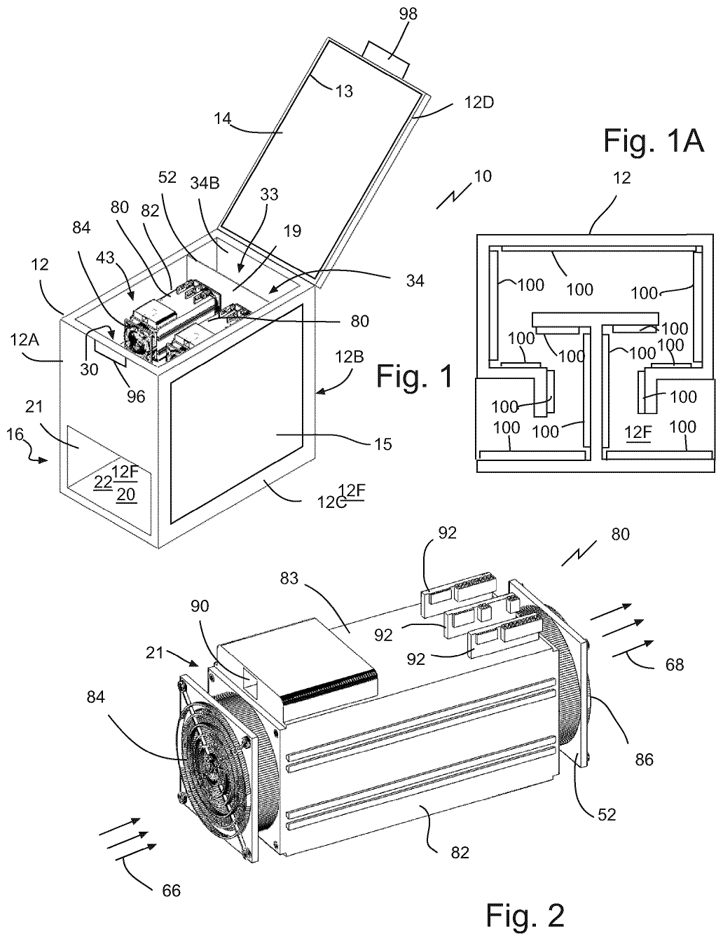

Referring to FIGS. 1, 3, 4, and 6, a blockchain mining system 10 is illustrated. The mining system 10 comprises a portable housing 12, an air inlet 16, an air outlet 18, and an internal frame 19. The portable housing 12 may be formed of panels, such as walls 12A-C, a base 12E, and a roof 12D. The panels may be connected together by suitable mechanisms (such as welding or fasteners), or formed partially or entirely integrally together to create the housing 12. The panels may cooperate to form an enclosure 12I, such as a weatherproof enclosure as shown, which defines an interior 12F that contains the internal parts such as a processor 80 (discussed later). The air inlet 16 may be defined in an inlet panel, such as front side wall 12A, of the panels. The air outlet 18 may be defined in an outlet panel, such as rear side wall 12B, of the panels. The side walls 12A and 12B may be opposite one another, for example defined as opposed side walls as shown. The internal frame 19 may be located, for example connected or partially or entirely integrally formed within the portable housing 12. The internal frame 19 may define a cooling air passageway 21. Passageway 21 may include a labyrinthine inlet conduit 20, for example extended to the air inlet 16. Passageway 21 may extend to and include a blockchain mining processor mounting zone 43, for example that is connected to the labyrinthine inlet conduit 20. Passageway 21 may include a labyrinthine outlet conduit 33, for example that is connected to the ASIC processor mounting zone 43 and the air outlet 18. One or more blockchain mining processors 80 may be mounted within the blockchain mining processor mounting zone 43. During use, the blockchain mining processor 80 may be operated to process blockchain transactions, for example in a distributed blockchain ledger system. The housing 12 may provide a protective enclosure for one or more bitcoin mining ASICs. An ergonomic and practical system 10 may be provided for deploying ASICs in a variety of locations, such as in the field, adjacent a building, or in a home. One or more air movers, for example fans, may be provided, for example as part of the processors 80 and/or the housing 12, and may be connected to direct air through the cooling air passageway 21 from the air inlet 16 to the air outlet 18.

Referring to FIG. 2, the blockchain mining processor 80 may comprise an application-specific integrated circuit (ASIC) chip. An ASIC may be an integrated circuit (IC) chip customized for a particular use, rather than intended for general-purpose use. For example, a chip designed to run in a digital voice recorder or a high-efficiency bitcoin miner is an ASIC. Application-specific standard product (ASSP) chips may be intermediate between ASICs and industry standard integrated circuits like the 7400 series or the 4000 series. ASIC chips may be typically fabricated using metal-oxide-semiconductor (MOS) technology, as MOS integrated circuit chips. As feature sizes have shrunk and design tools improved over the years, the maximum complexity (and hence functionality) possible in an ASIC has grown from 5,000 logic gates to over 100 million. Modern ASICs often include entire microprocessors, memory blocks including ROM, RAM, EEPROM, flash memory and other large building blocks. Such an ASIC is often termed a SoC (system-on-chip). Designers of digital ASICs often use a hardware description language (HDL), such as Verilog or VHDL, to describe the functionality of ASICs. Field-programmable gate arrays (FPGA) are the modern-day technology for building a breadboard or prototype from standard parts; programmable logic blocks and programmable interconnects allow the same FPGA to be used in many different applications. For smaller designs or lower production volumes, FPGAs may be more cost-effective than an ASIC design, even in production. The non-recurring engineering (NRE) cost of an ASIC can run into the millions of dollars. Therefore, device manufacturers typically prefer FPGAs for prototyping and devices with low production volume and ASICs for very large production volumes where NRE costs can be amortized across many devices. One or more ASIC chips may be contained on each processor 80, for example located in single or plural arrays or groups in one or more hash boards 92.

Referring to FIG. 2, each processor 80 may have suitable characteristics. The example shown illustrates an S9i™ rig manufactured and sold in association with the ANTMINER™ brand by BITMAIN™ for the purpose of mining Bitcoin transactions. The processor 80 may incorporate one or more controllers 83. The Antminer™ S9i™'s control board (controller 83) employs the fast Dual ARM® Cortex®-A9 microprocessor with CoreSight™. The S9i's control board may use a Xilinx® Zynq®-7000 series FPGA with a Dual ARM® Cortex®-A9 microprocessor. The processor 80 may comprise a network connector 90 (for an ethernet cable), such as one that supports Gigabit Ethernet to ensure that mined blocks are submitted instantly. Each processor board 92 may be mounted on a body 82 of the processor 80, and contains one or more application-specific integrated circuit chips. Each Antminer™ S9i™ employs a plurality of ASICs, for example 189 such chips to deliver more hash rate and efficiency than any bitcoin miner ever made before it. The processor 80 may comprise a suitable body 82 upon which to mount components. In the example shown, body 82 is a high-grade aluminum case.

Referring to FIG. 2, the processor 80 may include one or more cooling mechanisms. The body 82 may include one or more heat-sinks. One or more fans may be connected to direct air through the cooling air passageway 21, and across the ASIC processor 80, to maintain the ASIC processor 80 within a respective operating range of temperature during use. One or more temperature sensors (not shown) may be used to monitor temperature and adjust fan and/or computing operation. The fans may include an intake fan 84 at an intake end of the body 82. The fans may include a discharge fan 86 at a discharge end of the body 82. By using two computer-controlled high-speed fans 84 and 86 on both ends of a tube-shaped body 82, hot air is rapidly replaced by cooler air at the required pace. By using two computer-controlled fans to keep the processor 80 cool, the processor 80 remains efficient and powerful. The processor 80 may use a combination of conduction and convection cooling to make the miner perform best without getting hotter than any other terahash bitcoin miner. In some cases, each chip of the processor 80 may be fitted with custom-made heat sinks, for example that are made of a high-grade Aluminum alloy.

Referring to FIG. 2, the processor 80 may include other components to operate the processor 80 in a suitable fashion. The processor 80 may include a power connector such as containing circuitry to connect to a suitable power source, such as an A/C wall outlet cord. Power may be supplied into the PCIe (peripheral component interconnect express) ports on the hash boards at the top of the unit, or at another suitable location. One or more power distribution units, such as a power strip, may be used. One or more power converters may be used to convert incoming power to a usable form, for example having one or more inverters, transformers, or other suitable mechanisms. The processor 80 may interface with an online control application software, such as providing a user interface that permits a user to begin mining with only a network connection, a wallet address, and mining pool credentials. A mechanism may exist for periodically updating the firmware of the controller.

Referring to FIG. 1, the portable housing 12 may have a suitable access door. The panels, such as a roof 12D, may define or form a processor access door that is structured to open to the ASIC processor mounting zone 43. The roof 12D in the example forms a lid that is pivotally connected, for example by a suitable hinge (not shown), to a side wall 12A, 12B, or 12C of the panels. The processor access door, such as roof 12D, may comprises peripheral weatherstripping 13, for example a peripheral lip seal or rubber, silicone, or other suitable flexible material. One or more locks, for example a latch 98 that connects to a catch 96 in use, may be provided to secure the roof 12D in the closed position, for example for security during use. A locking system may function to provide a compression seal, by applying closing pressure that squeezes and seals any weatherstripping 13 or other door seals present, for example to keep elements such as moisture out and to prevent undesirable convective movement through the door seals. A side wall, such as wall 12C, of the panels may form the processor access door in some cases, for example door 15 as shown. A suitable door may be one or more of pivotally connected, slidable, or removable. The door, such as roof 12D, and/or the rim about which the door seals, such as provided by the top edges of walls 12A-12C (front wall 12A, rear wall 12B, and side walls 12C), may include a peripheral skirt or rim, respectively, to facilitate weatherproofing of the housing 12 when the door is closed. The ASICs may easily be installed/removed due to the top lid or side swing door access. Lids and doors may incorporate suitable hardware such as hinges for the lid, spring compression clasps to hold the lid shut tightly, a lock for the lid, and handles.

Referring to FIG. 6, the ASIC processor 80 and inlet/outlet 16, 18, respectively, may be located at suitable locations on or in the housing 12. The ASIC processor mounting zone 43 may be elevated, for example above the base 12E, for further example to a position adjacent a roof 12D of the panels. In the example shown the processor 80 is mounted in the zone 43 in the top forty percent of the height of the housing 12. One or more of the air inlet 16 and air outlet 18 may be located adjacent base ends of the inlet side wall 12A and outlet side wall 12B, respectively. In the example shown, the processor 80 is mounted above the inlet 16 and outlet 18. Providing the ASIC processor 80 above the air intake/discharge, and above any local low point that allows drainage if any liquid ingress or flooding occurs, may act to protect the ASICs from contact with such liquid, permitting draining before such liquid reaches the ASICs. The interior base surfaces of the internal frame 19 may be sloped or otherwise structured to facilitate drainage out of the housing 12.

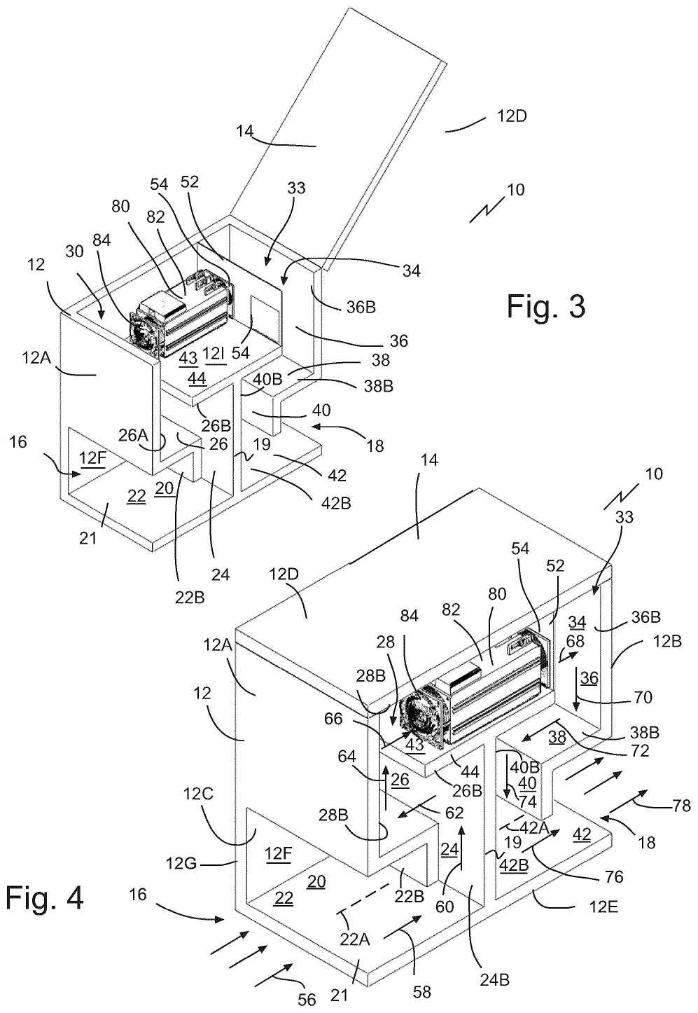

Referring to FIGS. 3, 4, and 6, the internal frame 19 and housing 12 may have a suitable geometry and structure. The internal frame 19 may comprise a divider wall 24B that separates the labyrinthine inlet conduit 20 and labyrinthine outlet conduit 33. The divider wall 24B may directly or indirectly elevate and support the ASIC processor 80, for example the ASIC processor mounting zone 43 may comprise a shelf 44 that is supported by the divider wall 24B above the divider wall 24B, which may act as a column. The internal framework of the housing 12 may be structured and oriented for flexibility of use and configuration. For example, the internal frame 19 may be oriented to permit the reverse of air flow through the passageway 21, for example if inlet 16 and outlet 18 become an outlet and inlet, respectively, and the processor 80 were mounted backward from what is shown in the figures. The divider wall 24B may at least partially bisect the enclosure 12I, for example as shown where the base portion of the housing 12 is bisected. The main support wall (divider wall 24B) may be provided in the middle of the cross-sectional shape as shown, acting as a divider between the low pressure, cool intake and the higher pressure, hot discharge. The internal frame 19 may define a central plane of symmetry between the air inlet 16 and the air outlet 18. The axial lengths of both conduits 20 and 33 may be similar or identical. Symmetrical air flow paths mean that the air intake/discharge can be either side of the system 10. Constructability may be relatively simple, modular, at low cost and repeatable.

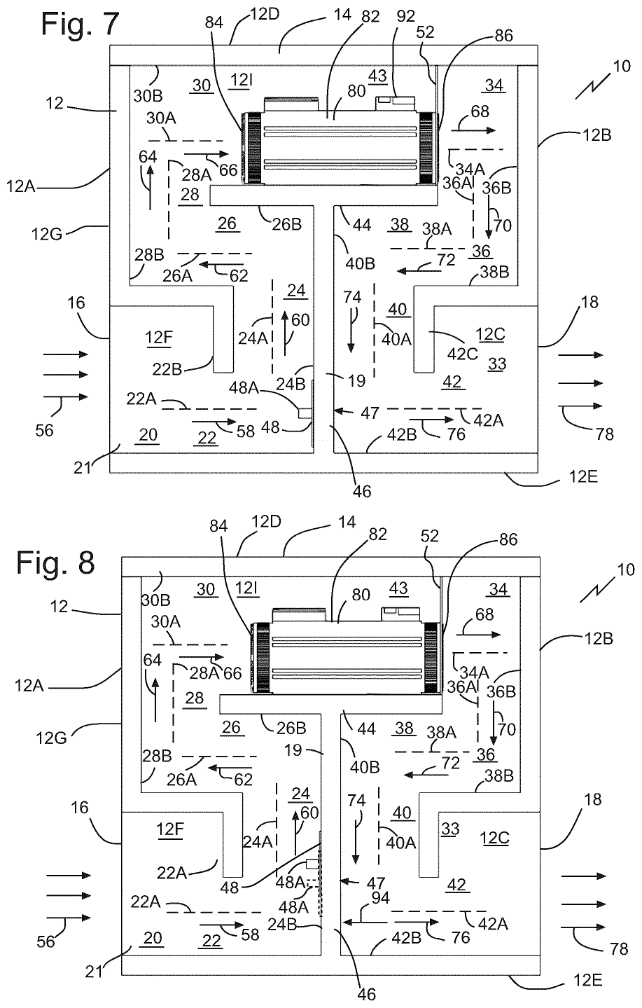

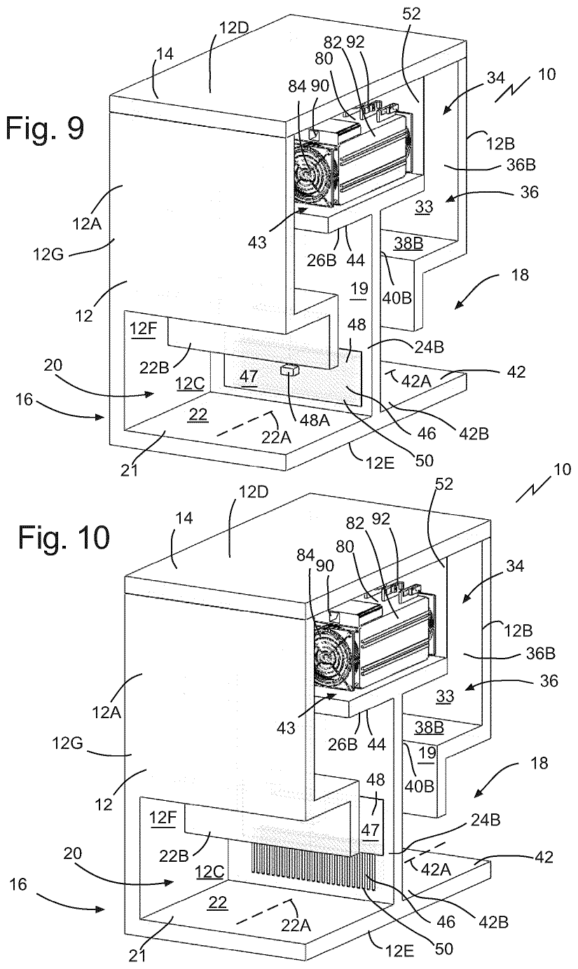

Referring to FIGS. 7-10, the system 10 may be structured to permit controlled recirculation of heated exhaust air into circulation within the passageway 21 upstream of the ASIC processor zone 43. An adjustable air recirculation valve 47 may be provided. Valve 47 may be connected to permit a controlled range of bypass of cooling air from the labyrinthine outlet conduit 33 back to the labyrinthine inlet conduit 20, for example along direction arrow 94. The adjustable air recirculation valve 47 may comprise a slider door, for example having a panel 48 or other blocking part, mounted to a recirculation port 46. The valve 47 may be manually or automatically adjustable. In the example shown, the valve 47 has a handle 48A and operates similar to a heat register in a building, where the user or a controller adjusts the amount of recirculation permitted from zero percent to one hundred percent recirculation by moving the panel 48 between the closed (FIGS. 7 and 9) and open (FIGS. 8 and 10) positions. In FIG. 8, an intermediate position is illustrated in dashed lines to demonstrate how a range of positions may be used. An automatic system may involve a controller (not shown) and actuator (not shown) for adjusting the position of the valve 47 to achieve a desired range of mining processor 80 temperatures during operation. The valve 47 may be adjusted in response to ambient temperatures outside the housing 12, for example via one or more thermostats (not shown) or other temperature sensors. Referring to FIG. 10, a filter, such as a grating 50 may be provided over the port 46. The heat recirculation air register/slider may allow a user to put heat back towards the intake in cold weather to melt any snow ingress that accumulates, as well as to pre-heat the air heading into the ASIC to prevent ASIC temperatures dropping out of a suitable operating range of temperatures.

Referring to FIGS. 4 and 6, labyrinthine inlet and outlet conduits 20 and 33 may be defined by the internal framework of the housing 12. A labyrinthine conduit may provide a circuitous passageway with changing directions, forming a spiral, winding, and/or serpentine course or path for air to travel through enroute to and from the ASIC processor mounting zone 43. A labyrinthine flow path may act to dampen noise from the processor(s) 80 and allow any moisture such as rain or snow to drop out prior to reaching the ASIC processor 80.

Referring to FIGS. 4 and 6, the labyrinthine inlet conduit 20 may comprises one or more inlet conduit portions connected in series between the air inlet 16 and the ASIC processor mounting zone 43. In the example shown, inlet conduit portions include, in series, first, second, third, and fourth inlet conduit portions 22, 24, 26, and 28, each defining its own axis 22A, 24A, 26A, and 28A, respectively of air flow through the passageway 21. Each downstream inlet conduit portion of the one or more inlet conduit portions may be oriented to define a downstream inlet conduit portion axis angled at ninety degrees or more from an upstream inlet conduit portion axis of an adjacent upstream inlet conduit portion of the one or more inlet conduit portions. Thus, for example, inlet conduit portion 24 is downstream of and angled relative to inlet conduit portion 22, which is upstream of inlet conduit portion 24, and axis 24A of inlet conduit portion 24 is angled at ninety degrees relative to axis 22A of inlet conduit portion 22. Similarly, axis 26A is ninety degrees relative to axis 24A, and axis 28A is ninety degrees relative to axis 26A. The ASIC processor mounting zone 43 may define an intake conduit portion 30, whose axis 30A is ninety degrees or more angled to axis 28A of conduit portion 28. The structure shown provides an S-shaped circuitous conduit from air inlet 16 to ASIC processor 80, providing several stages of sound dampening without significant loss of air pressure or increase in air mover power requirements. In some cases, angles less than ninety degrees may be used between adjacent conduit portions. The downstream and upstream inlet conduit portion axes, for example each of axes 22A, 24A, 26A, and 28A (and in some cases axes 30A) may be defined in a common plane as shown although other configurations may be used out of a plane.

Referring to FIGS. 4 and 6, each downstream inlet conduit portion may have a respective diverter wall structured to change air flow direction by at least ninety degrees from the adjacent upstream inlet conduit portion. Diverter walls, such as walls 24B, 26B, 28B (and in some cases wall 30B of intake conduit portion 30) may act to block all lines of sight from the adjacent upstream inlet conduit portion into the downstream inlet conduit portion. Each diverter wall may form a terminal end of a respective upstream inlet conduit portion, diverting flow, dampening sound in the process and assisting in separating condensed fluid from the cooling air. One or more baffle walls, such as baffle wall 22B of conduit portion 22, may be present. Air flow may travel to ASIC processor mounting zone 43 along direction arrows 56 through inlet 16, into conduit portion 22 along arrows 58. Diverter wall 24B may redirect air flow into conduit portion 24 along arrows 60. Diverter wall 26B may redirect air flow into conduit portion 26 along arrows 62. Diverter wall 28B may redirect air flow into conduit portion 28 along arrows 64. Diverter wall 30B may redirect air flow into conduit portion 30 along arrows 66. Air flow thus enters body 82 via fan 84, exchanging and absorbing heat from processor 80 in the process, existing body 82 via discharge fan 86.

Referring to FIGS. 4 and 6, the labyrinthine outlet conduit 20 may comprises one or more outlet conduit portions connected in series between the ASIC processor mounting zone 43 and air outlet 18. In the example shown, outlet conduit portions include, in series, first, second, third, and fourth outlet conduit portions 36, 38, 40, and 42, each defining its own axis 36A, 38A, 40A, and 42A, respectively of air flow through the passageway 21. Each downstream outlet conduit portion of the one or more outlet conduit portions may be oriented to define a downstream outlet conduit portion axis angled at ninety degrees or more from an upstream outlet conduit portion axis of an adjacent upstream outlet conduit portion of the one or more outlet conduit portions. Thus, for example, outlet conduit portion 38 is downstream of and angled relative to outlet conduit portion 36, which is upstream of outlet conduit portion 38, and axis 38A of outlet conduit portion 38 is angled at ninety degrees relative to axis 36A of outlet conduit portion 36. Similarly, axis 40A is ninety degrees relative to axis 38A, and axis 42A is ninety degrees relative to axis 40A. The ASIC processor mounting zone 43 may define a discharge conduit portion 34, whose axis 34A is ninety degrees or more angled to axis 36A of conduit portion 36. The structure shown provides an S-shaped circuitous conduit from ASIC processor 80 to air outlet 18, providing several stages of sound dampening without significant loss of air pressure or increase in air mover power requirements. In some cases, angles less than ninety degrees may be used between adjacent conduit portions. The downstream and upstream outlet conduit portion axes, for example each of axes 36A, 38A, 40A, 42A (and in some cases axes 34A) may be defined in a common plane as shown although other configurations may be used out of a plane.

Referring to FIGS. 4 and 6, each downstream outlet conduit portion may have a respective diverter wall structured to change air flow direction by at least ninety degrees from the adjacent upstream outlet conduit portion. Diverter walls, such as walls 36B, 38B, 40B, and 42B may act to block all lines of sight from the adjacent upstream outlet conduit portion into the downstream outlet conduit portion. Each diverter wall may form a terminal end of a respective upstream conduit portion, diverting flow, and dampening sound in the process. One or more baffle walls, such as baffle wall 42C of conduit portion 42, may be present. Air flow may travel from ASIC processor mounting zone 43 along direction arrows 68 through conduit portion 34 to diverter wall 36B, into conduit portion 36 along arrows 70. Diverter wall 38B may redirect air flow into conduit portion 38 along arrows 72. Diverter wall 240B may redirect air flow into conduit portion 40 along arrows 74. Diverter wall 42B may redirect air flow into conduit portion 42 along arrows 76. Air flow thus exits body 82 via outlet 18 along direction arrows 78 into the ambient environment and/or recirculates back through open port 46 into conduit portion 24.

Referring to FIGS. 2 and 6, the ASIC processor mounting zone 43 may include a pressure barrier 52. Barrier 52 may be oriented in a suitable fashion, for example across the cooling air passageway 21 within the ASIC processor mounting zone 43. The pressure barrier 52 may define a discharge port 54 structured to mount to a discharge end (for example discharge fan 86) of a body 82 of an ASIC processor 80. The pressure barrier 52 may provide a mounting surface for the processor 80. The pressure barrier 52 may form an interface between the high and low pressure conduits 33 and 21, respectively, to prevent unwanted recirculation between the conduits. The pressure barrier 52 may have a suitable structure, such as a plate as shown.

Referring to FIG. 1A, the system 10 may incorporate acoustic insulation. In the example shown, one or more of the panels may comprise acoustic insulation, such as acoustic insulation panels 100. The interior surfaces or some or all of same of the internal frame 19 may have disposed thereon acoustic paneling. Acoustic panels (also called sound absorption panels, soundproof panels or sound panels) may be sound-absorbing fabric-wrapped boards designed to control echo and reverberation in a room. Acoustic panels may be constructed in a suitable fashion, such as with a wooden frame, filled with sound absorption material (mineral wool, fiber glass, cellulose, open cell foam, or combination of) and wrapped with fabric. In some cases, acoustic foam may be used. Acoustic foam may include an open celled foam used for acoustic treatment. Acoustic foam may attenuate airborne sound waves, reducing amplitude, for the purposes of noise reduction or noise control. The energy is dissipated as heat. Acoustic foam may be made in several different colors, sizes and thickness. Acoustic foam may be attached to the walls, ceiling, doors, floor, and other features of the portable housing 12 to control noise levels, vibration, and echoes. In some cases, the housing 12 structure is made, for example, from urethane foam panels cladded in steel to suppress sound waves from permeating outside to the exterior 12G of the housing 12.

In some cases, portions or all of the housing 12 and/or internal frame 19 may be treated to provide fire or flame retardant characteristics. Acoustic foam products may be used that are treated with fire retardants. The term flame retardant subsumes a diverse group of chemicals which are added to manufactured materials, such as plastics and textiles, and surface finishes and coatings. Flame retardants may be activated by the presence of an ignition source and are intended to prevent or slow the further development of ignition by a variety of different physical and chemical methods. Such may be added as a copolymer during the polymerization process, or later added to the polymer at a molding or extrusion process or (particularly for textiles) applied as a topical finish. Mineral flame retardants may be typically additive while organohalogen and organophosphorus compounds may be either reactive or additive. Intumescent or other materials may be used. Fire proofing may act to enable high-power energized ASICs to operate within a home or outside a home safely, as such are known in poorly ventilated contexts to catch fire now and then. Such will also make mining safer adjacent flammable materials such as wood or plastic, which are commonly present in homes and buildings.

Referring to FIG. 6, the system 10 may incorporate one or more air filters. The air inlet 16 may incorporate an inlet filter 16A, for example over the air inlet 16 The air outlet 18 may incorporate an outlet filter 18A. A screen may be used as a filter. In some cases, a high efficiency particulate air (HEPA) filter may be used, or another suitable filter. HEPA is a type of pleated mechanical air filter. This type of air filter can theoretically remove at least 99.97% of dust, pollen, mold, bacteria, and any airborne particles with a size of 0.3 microns (μm). A screen or other filter may prevent ingress of external elements, as well as ingress of animals, insects, plants, and fungi.

Referring to FIGS. 1, 3, 4, and 6, the housing 12 and system 10 may form a weatherproof enclosure 12I. Weatherproof may refer to the system 10's ability to withstand exposure to weather in an outdoor, unprotected environment without damage or loss of function. Various aspects may contribute to a weatherproof system. The use of a hinged lid, or other access door (roof 12D) that is sealed from elements using weather stripping and compression clamps may assist. The use of labyrinthine conduits 20 and 33 may provide an air flow path snake-way that has direction changes that help drop out liquids and airborne particulates that may otherwise deleteriously travel into the intake of the processor 80. Providing ASICs that are elevated above the air intake/discharge may allow drainage if any liquid ingress or flooding before liquid reaches the ASIC. The heat recirculation air register/slider may allow a user to put heat back towards the intake in cold weather to melt any snow ingress that accumulates as well as pre-heat the air heading into the ASIC.

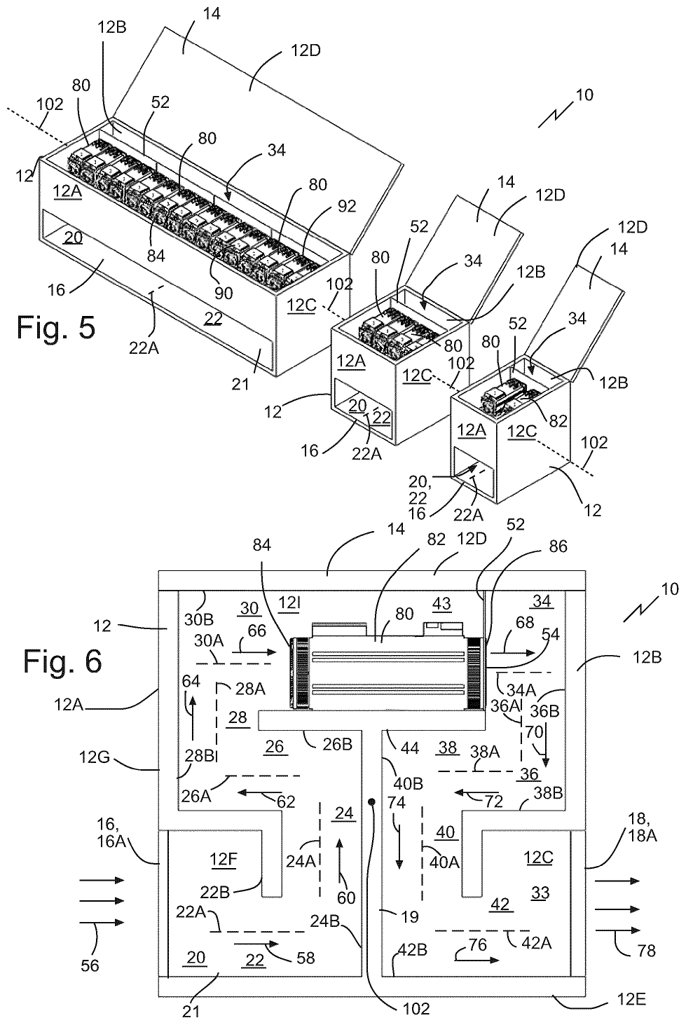

Referring to FIG. 5, system 10 may provide a compact enclosure that may be scaled during manufacturing in a convenient fashion. In the example shown, the system 10 may be scaled to multiple power levels (multiple ASICs) and heat dissipation by simply extending a width of the enclosure, for example measured along a Z-axis 102 between side walls 12C of the housing in the example. A width of the portable housing 12 may be selected as desired, for example twenty inches (right-most housing 12), twenty-eight inches (middle housing 12), or ninety-six inches (left most housing), or smaller or greater widths. In the example shown, the housing 12 may be scaled completely linearly down the Z axis 102 to scale more power. As shown, a plurality of ASIC processors 80 may be mounted within the ASIC processor mounting zone 43 of each housing 12, with wider housings 12 providing more space for additional processors 80. Referring to FIG. 6, a shown, the plurality of ASIC processors 80 may be mounted in parallel along a lateral mounting axis (such as axis 102) transverse to an air flow axis (such as axes 30A and 34A) defined across the ASIC processors 80 within the ASIC processor zone 43. Scalability in the Z-axis 102 gives the housing 12 an extruded shape, that is, the appearance of a unit that has been formed by an extrusion process.

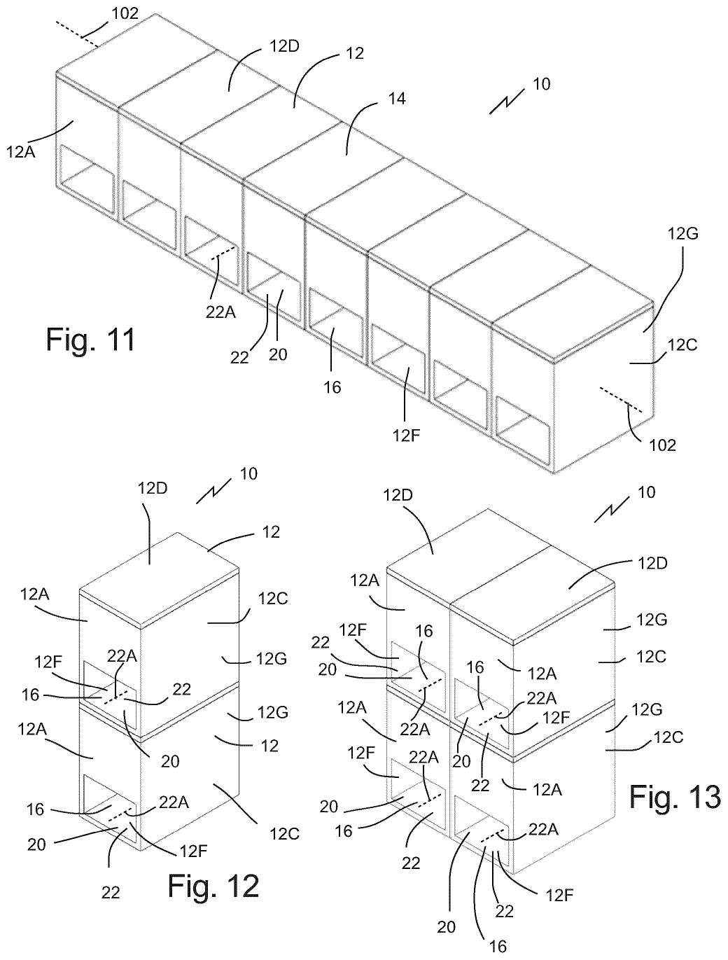

Referring to FIGS. 11-13, various configurations of vertically and/or horizontally stacked arrangements of housings 12 is illustrated. Referring to FIGS. 12 and 13, two or more of the portable ASIC housings 12 may be stacked in a vertical stack one on top of the other. Stacked housings 12 may be secured together using respective module mounting mechanisms, or may rest one upon the other without any securing mechanism. Referring to FIGS. 11 and 13, two or more of the portable ASIC housings 12 may be arranged in a horizontal row. Horizontally adjacent housings 12 may contact one another, and may be unsecured, or secured together using respective module mounting mechanisms. Referring to FIGS. 11-13, the portable ASIC housings 12 may be aligned such that the air inlets 16 are located in the same plane, allowing the axes 22A of the first conduits 22 to be aligned for all the housings 12. Similarly, the housings may be aligned such that the air outlets (not shown) are located in the same plane. Thus, the modules may cooperate together to draw air in and out of each housing 12 from the same sides as one another, taking air in from one side of the stack/row, and exhausting air from the other side of the stack/row, avoiding unintended recirculation and permitting increased power density within a minimized footprint of space. Referring to FIGS. 12 and 13, the module mounting mechanism may comprise parts (not shown) that secure modules to one another when vertically stacked one on the other. The module mounting mechanism may comprise cooperating mounting parts on the roofs 12D and the bases 12E of respective portable ASIC housings 12 to permit the housings to mount together. Referring to FIGS. 11 and 13, the housing 12 may comprise parts (not shown) that secure modules to one another when arranged in horizontal rows adjacent one another in abutting relationship. Each housing 12 may be structured to permit adjacent respective portable ASIC housings 12 that are identical to the housing 12 in a relevant set of applicable dimensions to be secured to form a horizontal row of portable ASIC modules.

Relative words such as front and rear, sides, left and right, up and down are arbitrary and do not refer to absolute orientations unless context dictates otherwise. For example, although the description refers to rear and front ends, it should be understood that this orientation could be reversed. Similarly, side walls need not be the walls with the longest lateral dimensions (although in many cases they will be), for example in the case of a cube container. Features in various embodiments may be interchanged, for example to provide an air inlet in the floor and an outlet in the roof. The system 10 may form a skid, or may form a wheeled or tracked unit, such as a trailer. In some cases, system 10 may incorporate a motor to drive the system 10 to different locations. A reference to a floor may refer to a base of a component, or it may refer to a floor above a base. In some cases, the systems 10 or modules may come with processor mounts without the processors themselves. The datacenters disclosed herein do not need to be operated to mine in a blockchain context, and can be used as other forms of datacenters or computational processors.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A blockchain mining system comprising:
a portable housing, formed of panels that cooperate to form an enclosure;
an air inlet defined in an inlet panel of the panels;
an air outlet defined in an outlet panel of the panels;
an internal frame within the portable housing, the internal frame defining a cooling air passageway that includes:
a labyrinthine inlet conduit to the air inlet;
a blockchain mining processor mounting zone that is connected to the labyrinthine inlet conduit; and
a labyrinthine outlet conduit to the blockchain mining processor mounting zone and the air outlet.

2. The portable blockchain mining system of claim 1 in which the blockchain mining processor mounting zone is elevated above the base to a position adjacent a roof of the panels.

3. The portable blockchain mining system of claim 1 in which the panels define or form a processor access door that is structured to open to the blockchain mining processor mounting zone.

4. The portable blockchain mining system of claim 3 in which a roof of the panels forms the processor access door and is pivotally connected to a side wall of the panels.

5. The portable blockchain mining system of claim 1 in which:
the air inlet is defined in an inlet side wall of the panels; and
the air outlet is defined in an outlet side wall of the panels.

6. The portable blockchain mining system of claim 5 in which:
the air inlet and air outlet are located adjacent base ends of the inlet side wall and outlet side wall, respectively; and
the inlet side wall and the outlet side wall are opposite one another.

7. The portable blockchain mining system of claim 1 in which:
the internal frame comprises a divider wall separating the labyrinthine inlet conduit and labyrinthine outlet conduit; and
the divider wall at least partially bisects the enclosure.

8. The portable blockchain mining system of claim 7 in which the blockchain mining processor mounting zone comprises a shelf supported by the divider wall above the divider wall.

9. The portable blockchain mining system of claim 1 further comprising an adjustable air recirculation valve connected to permit a controlled range of bypass of air from the labyrinthine outlet conduit back to the labyrinthine inlet conduit.

10. The portable blockchain mining system of claim 9 in which the adjustable air recirculation valve comprises a slider door mounted to a recirculation port.

11. The portable blockchain mining system of claim 1 in which the labyrinthine inlet conduit comprises one or more inlet conduit portions connected in series between the air inlet and the blockchain mining processor mounting zone, with each downstream inlet conduit portion of the one or more inlet conduit portions oriented to define a downstream inlet conduit portion axis angled at ninety degrees or more from an upstream inlet conduit portion axis of an adjacent upstream inlet conduit portion of the one or more inlet conduit portions.

12. The portable blockchain mining system of claim 11 in which the one or more inlet conduit portions comprise:
a first inlet conduit portion connected to the air inlet;
a second inlet conduit portion connected to the first inlet conduit portion and defining a second inlet conduit portion axis angled at ninety degrees or more from a first inlet conduit portion axis of the first inlet conduit portion;
a third inlet conduit portion connected to the second inlet conduit portion and defining a third inlet conduit portion axis angled at ninety degrees or more from the second inlet conduit portion axis; and
a fourth inlet conduit portion connected to the third inlet conduit portion and the blockchain mining processor mounting zone and defining a fourth inlet conduit portion axis angled at 90 degrees or more from the third inlet conduit portion axis.

13. The portable blockchain mining system of claim 11 in which the downstream and upstream inlet conduit portion axes are defined in a common plane.

14. The portable blockchain mining system of claim 1 in which the labyrinthine outlet conduit comprises one or more outlet conduit portions connected in series between the blockchain mining processor mounting zone and the air outlet, with each downstream outlet conduit portion of the one or more outlet conduit portions oriented to define a downstream outlet conduit portion axis angled at ninety degrees or more from an upstream outlet conduit portion axis of an adjacent upstream outlet conduit portion of the one or more outlet conduit portions.

15. The portable blockchain mining system of claim 14 in which the one or more outlet conduit portions comprise:
a first outlet conduit portion connected to the blockchain mining processor mounting zone;
a second outlet conduit portion connected to the first outlet conduit portion and defining a second outlet conduit portion axis angled at ninety degrees or more from a first outlet conduit portion axis of the first outlet conduit portion;
a third outlet conduit portion connected to the second outlet conduit portion and defining a third outlet conduit portion axis angled at ninety degrees or more from the second outlet conduit portion axis; and
a fourth outlet conduit portion connected to the third outlet conduit portion and the air outlet and defining a fourth outlet conduit portion axis angled at 90 degrees or more from the third outlet conduit portion axis.

16. The portable blockchain mining system of claim 14 in which the downstream and upstream outlet conduit portion axes are defined in a common plane.

17. The portable blockchain mining system of claim 1 further comprising a pressure barrier oriented across the cooling air passageway within the blockchain mining processor mounting zone, the pressure barrier defining a discharge port structured to
mount to a discharge end of a body of a blockchain mining processor.

18. The portable blockchain mining system of any one of claim 1 in which the internal frame defines a central plane of symmetry between the air inlet and the air outlet.

19. The portable blockchain mining system of claim 1 in which one or more of the panels comprise acoustic insulation.

20. The portable blockchain mining system of claim 1 further comprising one or more of:
an inlet filter over the air inlet; and
an outlet filter over the air outlet.

21. The portable blockchain mining system of claim 1 in which the enclosure is a weatherproof enclosure.

22. The portable blockchain mining system of claim 1 further comprising one or more blockchain mining processors mounted within the blockchain mining processor mounting zone.

23. The portable blockchain mining system of claim 22 in which a plurality of blockchain mining processors are mounted in parallel along a lateral mounting axis transverse to an air flow axis defined across the blockchain mining processors within the blockchain mining processor zone.

24. The portable blockchain mining system of claim 22 in which each blockchain mining processor comprises:
a body;
a processor board mounted on the body and containing one or more application-specific integrated circuit chips;
a controller;
a power connector;
a network connector; and
one or more fans connected to direct air through the cooling air passageway across the blockchain mining processor to maintain the blockchain mining processor within a respective operating range of temperature.

25. The portable blockchain mining system of claim 24 in which the one or more fans of each blockchain mining processor comprise:
an intake fan at an intake end of the body; and
a discharge fan at a discharge end of the body.

26. A method comprising operating the blockchain mining processor of the blockchain mining system of claim 21 to process blockchain transactions.

27. A method comprising operating a blockchain mining processor in a portable housing of a blockchain mining system to process blockchain transactions, while a cooling fan moves cooling air in series:
through a labyrinthine inlet conduit defined within the portable housing;
across the blockchain mining processor; and
through a labyrinthine outlet conduit defined within the portable housing;
to maintain the plurality of blockchain mining processors within a respective operating range of temperature.

28. The method of claim 27 in which the cooling fan moves cooling air through an air inlet defined in an inlet in the portable housing into the labyrinthine inlet conduit.

29. The method of claim 27 in which cooling air recirculates through an adjustable air recirculation valve from the labyrinthine outlet conduit back to the labyrinthine inlet conduit.

30. The method of claim 27 in which the cooling fan moves cooling air through the labyrinthine outlet conduit and to an air outlet defined in an outlet in the portable housing.
